(19) United States
(12) Patent Application Publication
(10) Pub. No.: US 2013/0024576 A1
(43) Pub. Date: Jan. 24, 2013

(54) Proximity-Based Detection

(71) Applicants: Darin J. Dishneau, Snoqualmie, WA (US); Patrick Joseph Derks, Seattle, WA (US); John A. Yovin, Woodinville, WA (US)

(72) Inventors: Darin J. Dishneau, Snoqualmie, WA (US); Patrick Joseph Derks, Seattle, WA (US); John A. Yovin, Woodinville, WA (US)

(73) Assignee: Microsoft Corporation, Redmond, WA (US)

(21) Appl. No.: 13/189,240

(22) Filed: Jul. 22, 2011

(51) Int. Cl. G06F 15/16; G06F 7/04

(52) U.S. Cl. 709/227

(57) ABSTRACT

Proximity-based detection is described. In one or more implementations, an identifier is received wirelessly by a computing device from another computing device that is directly communicated from the other computing device such that the identifier is not communicated via an intermediary device. The other computing device is identified by comparing the identifier to one or more identifiers stored locally by the computing device. A notification is output for display that indicates the other computing device is within a predefined proximity to the computing device and that identifies the other computing device using data associated with the identifier that is stored locally by the computing device.

### BACKGROUND

Mobile communications devices such as wireless phones have become a common part in the everyday life of a wide variety of users. Indeed, the mobile communications device may serve as a primary point of contact for a variety of business and personal uses. For example, a business user may utilize the mobile communications device to receive email, a casual user may send text messages to friends, and so on.

Because of this, a wide variety of techniques have been developed to enable users to quickly connect with other users. However, these techniques traditionally relied on network services and thus network access was also involved to implement the techniques, traditionally. Further, these techniques also typically involved user registration with the network service, management of permissions, and so on which could hinder the ease of use of the services.

### SUMMARY

Proximity-based detection is described. In one or more implementations, an identifier is received wirelessly by a computing device from another computing device that is directly communicated from the other computing device such that the identifier is not communicated via an intermediary device. The other computing device is identified by comparing the identifier to one or more identifiers stored locally by the computing device. A notification is output for display that indicates the other computing device is within a predefined proximity to the computing device and that identifies the other computing device using data associated with the identifier that is stored locally by the computing device.

In one or more implementations, a computing device includes a display device, a wireless module configured to communicate wirelessly with another computing device, and one or more modules implemented at least partially in hardware. The one or more modules are configured to receive an identifier from the other computing device using the wireless module, the identifier not including absolute location information for the other computing device, identify the other computing device by comparing the identifier with one or more identifiers that are associated with data.

In one or more implementations, one or more computer-readable storage media comprise instruction stored thereon that, responsive to execution by a computing device, cause the computing device to perform operations. The operations include identifying another computing device by comparing an identifier received wirelessly from the other computing device to one or more identifiers stored locally by the computing device, obtaining contact information that corresponds to the other computing device based on the identifying, and outputting a notification for display by the computing device that includes at least a portion of the contact information and that indicates the contact is within a predefined proximity to the computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a mobile communications device in accordance with one or more embodiments of devices, features, and systems for proximity-based notification techniques.

FIG. 2 depicts a system in an example implementation showing computing devices of FIG. 1 in greater detail as employing contact information for use in conjunction with proximity-based notifications.

FIG. 3 is a flow diagram depicting a procedure in an example implementation in which proximity of computing devices is determined using direct communication between the devices and used as a basis to output a notification.

FIG. 4 is a flow diagram depicting a procedure in an example implementation in which proximity of computing devices is determined without using data that describes an absolute location of the devices and used as a basis to output a notification.

FIG. 5 illustrates various components of an example computing device that can be implemented in various embodiments as any type of a device to implement embodiments of devices, features, and systems for proximity-based notification techniques described herein

### DETAILED DESCRIPTION

Overview

Computing devices such as mobile communications devices (e.g., mobile phones) have become an integral part of everyday life. Accordingly, techniques have been developed to leverage this pervasiveness to help users locate each other, such as through social network services. However, these techniques traditionally involved use of third party services, registration on the part of the users, shared absolute location information at all times such as to cause privacy issues, and so on which limited the usefulness of these traditional techniques.

Proximity-based detection techniques are described. In one or more implementations, techniques may leverage wireless functionality of a computing device (e.g., a mobile phone) to enable users to locate each other if so desired. For example, these techniques may leverage a wireless module of a mobile phone, such as a wireless module that is configured to provide Wi-Fi hotspot functionality. The mobile phone, for instance, may transmit an identifier (e.g., a MAC address) for receipt by other mobile phones within Wi-Fi range of the mobile phone. Therefore, when the mobile phone is within range, the other mobile phones may readily determine the proximity of the phones. Further, the identifier may be used in conjunction with user contact information to output a notification that identifies a likely user of the mobile phone. In this way, serendipitous output of notifications may be performed without involving a third-party party service or using absolute location information (e.g., geo-location information such as GPS coordinates), thereby preserving user privacy. Further discussion of these and other techniques may be found in relation to the following figures.

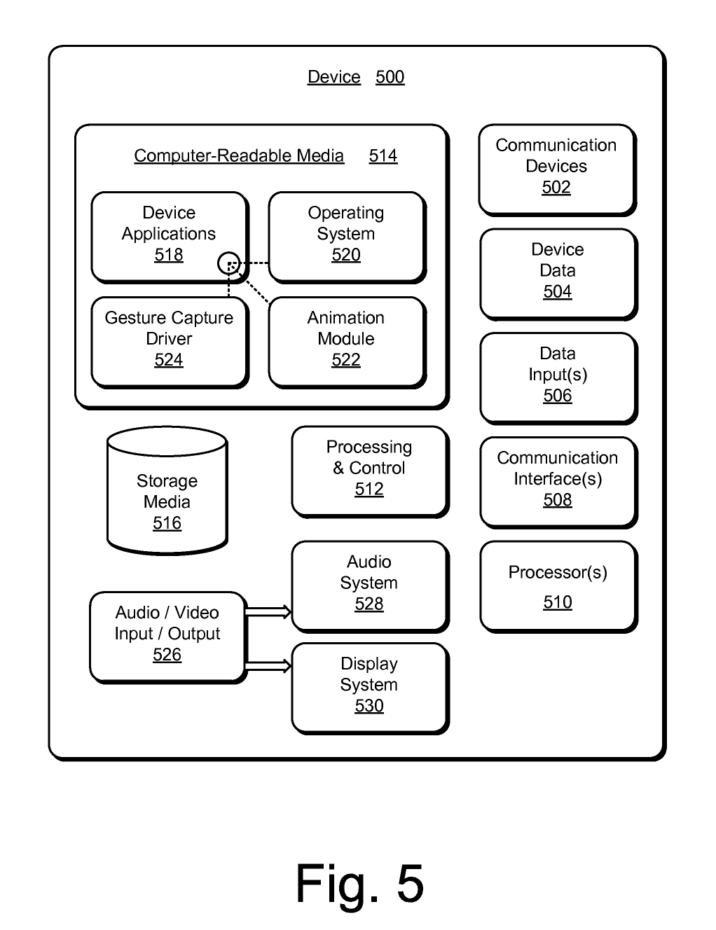

In the following discussion, a variety of example implementations of a computing device configured as a mobile communications device (e.g., a wireless phone) are described. Additionally, a variety of different functionality that may be employed by the mobile communications device is described for each example, which may be implemented in that example as well as in other described examples. Accordingly, example implementations are illustrated of a few of a variety of contemplated implementations. Further, although a mobile communications device having one or more modules that are configured to provide telephonic functionality are described, a variety of other computing devices are also contemplated, such as personal digital assistants, mobile music players, dedicated messaging devices, portable game devices, netbooks, and so on as further described in relation to FIG. 5.

Example Implementations

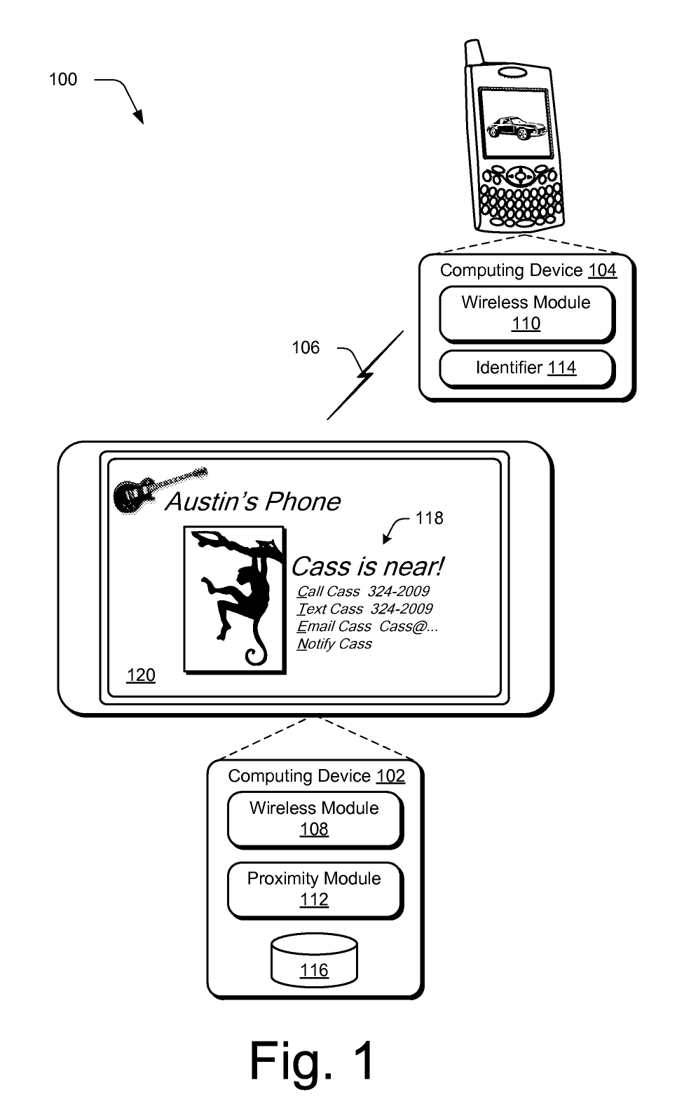

FIG. 1 is an illustration of an environment 100 in an example implementation that is operable to employ proximity-based notification techniques described herein. The illustrated environment 100 includes a computing device 102 as being configured to communicate with another computing device 104 via a wireless connection 106. The computing devices 102, 104 may be configured in a variety of ways. For example, the computing devices 102, 104 may be configured as computers that are capable of communicating over a wireless connection 106, such as a desktop computer, laptop computer, game console, set-top box, and so on.

The computing devices 102, 104 may also be configured as mobile communications devices that are configured for mobility, such as to be grasped in one or more hands of a user and powered via a battery. Examples of mobile communications device configurations are illustrated a mobile phone but may include a variety of other configurations, such as a tablet computer, portable messaging device, netbook, portable gaming device, assume a slate configuration, an entertainment appliance (e.g., a portable media player).

Thus, the computing devices 102, 104 may range from full resource devices with substantial memory and processor resources (e.g., personal computers, game consoles) to a low-resource device with limited memory and/or processing resources (e.g., traditional set-top boxes, hand-held game consoles). Additionally, although two instances of computing devices 102, 104 are shown, additional computing devices may also be employed in the environment 100 to leverage the techniques described herein.

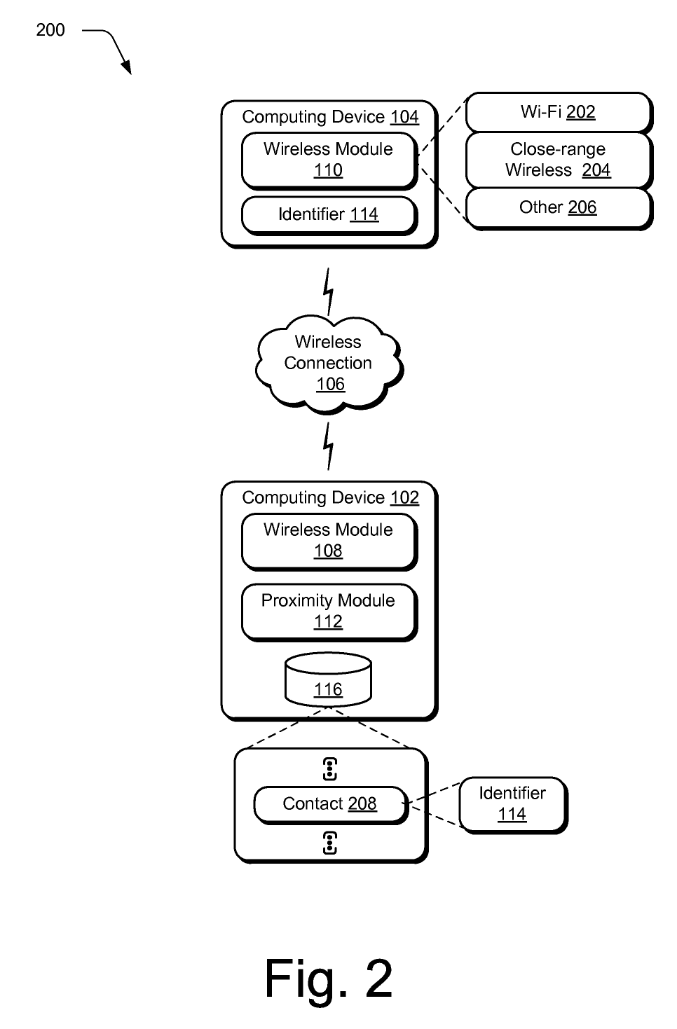

The computing devices 102, 104 are also illustrated as including respective wireless modules 108, 110. The wireless modules 108, 110 are representative of functionality of the respective devices to communicate wirelessly via the wireless connection 106. A variety of different wireless communication techniques may be employed by the wireless modules 108, 110 as further described in relation to FIG. 2. This wireless communication may be used to support a variety of different functionality.

An example of this functionality is further illustrated through inclusion of a proximity module 112 on the computing device 102. The proximity module 112 is representative of functionality of the computing device 102 to determine that the computing device 104 is within a predefined range. For example, the predefined range may be defined as within range of a particular wireless protocol to be used to communicate between the devices, ability to receive an identifier 114 via the wireless connection 106, within a defined level quality of service (QoS), and so forth.

For instance, the computing device 104 may be configured to broadcast the identifier 114 at predefined intervals, which may or may not be uniform, over the wireless connection 106 using the wireless module 110. The proximity module 112 of the computing device 102 may thus receive the identifier 114 via the wireless module 108 when within broadcast range of the computing device 104.

The identifier 114 may then be leveraged by the proximity module 112 to identify the computing device 104 using data, which may be stored locally in storage 116 of the computing device 102 although other remote implementations are also contemplated. The proximity module 112, for instance, may compare the identifier 114 with one or more identifiers stored in storage 116 that are associated with data that may be used to identify the computing device 104. This identification may be made in a variety of ways, such as by a name assigned for the computing device 104, a name of a likely user of the computing device 104, a company that owns the computing device 104, and so on.

An example of a notification 118 is illustrated as being displayed on a display device 120 of the computing device 102. In this example, the notification 118 identifies a likely user of computing device 104, e.g., “Cass,” along with a user tile associated with the user. The notification 118 also includes a plurality of options that are output automatically and without user intervention that may be used to communicate with the other computing device 104 and/or a likely user of the other computing device. For instance, options are included to call or text the other computing device 104 and thus these options are configured to communicate with the computing device 104 and a current user of the computing device 104.

An additional option is also included to contact a likely user of the device, e.g., to email “Cass” which is a person that is likely using the device but may or may not be actually using it. This, this additional option may be communicated to the computing device 104 as well as elsewhere, e.g., to a user's email account such that the user may communicate to other computing devices associated with the user.

A further option is also presented to “Notify Cass.” For instance, a user of the computing device 102, e.g., “Austin,” may set a configuration setting in which an identifier is not transmitted by the computing device 102 and thus computing device 104 cannot determine proximity of the computing device 102. In other words, Cass is not able to determine when Austin is near. However, in this instance selection of this option may enable such a notification to appear, such as to send transmit an identifier of the computing device 102 to enable the other computing device 104 to perform similar techniques using a respective proximity module.

In another instance, a notification may be specifically communicated to the computing device 104 to cause that computing device 104 to be aware that the other computing device 102 is in the proximity. For example, the notification may be preconfigured for output such that a comparison of an identifier is not performed by the other computing device 104. A variety of other examples are also contemplated, further discussion of which may be found beginning in relation to FIG. 2.

Although this example environment 100 described direct communication between the computing devices 102, 104 such that an intermediary device was not used, e.g., a web service, wireless access tower, and so on, it should be readily apparent that other implementations that do involve an intermediary device are also contemplated.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 depicts a system 200 in an example implementation showing the computing devices 102, 104 in greater detail as employing contact information for use in conjunction with proximity-based notifications. There may be a variety of different situations in which proximity-based notifications may be leveraged to inform users that other users are “in the area.” For example, as a user travels throughout their day the user may be unaware of situations when friends, colleagues, and so on may be near their location and therefore miss an opportunity to interact with them. For example, a friend may be on the other side of the aisle at a grocery store but not know it if the user does not venture down that isle, may miss a friend in a busy restaurant, and so on.

Traditional techniques involved “check in” type services in which users signed up to share geo-location information. However, this signup may involve a significant amount of time, may require that users be signed up to a matching service, and so on. Further, traditional techniques used to discovering a contacts location typically involved checking into a logical location (e.g., a specific place such as a local restaurant) at which point other users that have also checked into that location could be viewed. However, this required both users to manually perform a check-in operation before the users could discover each other. Other traditional techniques relied on the user to poll for a particular contacts location information, e.g., use of an AT&T family map. However, this required the user to have actively formed intent of finding a contact and thus could not provide support for happenstance meetings and thus was not serendipitous.

As previously described, in one or more implementations proximity-based notifications may be implemented using various wireless technologies without involving connectivity to a network service or the transfer of specific location information. There are a variety of wireless technologies that may be used to support this communication wirelessly over the wireless connection 106. For example, the wireless module 110 may be configured in accordance with Wi-Fi 202 (e.g., one or more IEEE 802.11 standards and add-ons), close-range wireless (e.g., Bluetooth), and other 206 wireless communication techniques such as Wi-MAX, IEEE 802.16.

Thus, the proximity-based notification techniques may leverage wireless functionality that may be found on a variety of computing devices. The computing device 104, for instance, may configure the wireless module 110 to function as a wireless access point (e.g., a “hotspot) such that other computing devices 102 may access a network (e.g., the Internet) through communication with the computing device 104, e.g., through tethering.

Accordingly, the identifier 114 may also be implemented in a variety of ways. The identifier 114, for instance, may identify wireless functionality (e.g., the wireless module 110) of the computing device, e.g., function as a MAC address. The MAC address may function as a unique identifier with which the proximity module 112 may associate with a particular contact 208. Therefore, when the computing device 102 is within reach of a signal from the computing device 104, the proximity module 112 may notify a user of the computing device 102 of the specific contact as described in relation to FIG. 1.

Thus, this scenario allows a simple setup on the computing device 102 that may be used to identify the computing device without employing a third party service or specific location. Further, this technique may leverage heuristics around determining appropriate ranges and even using multiple wireless technologies to provide various ranges. For example, a close-range wireless 204 technology (e.g., Bluetooth) may be used to determine that a user is closer than if detected solely using a Wi-Fi 202 wireless technology. Further, the proximity module 112 may also support serendipitous notification through use of a push mechanism which allows for happenstance meetings automatically and without user intervention past initial setup.

Example Procedures

The following discussion describes proximity-based notification techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 and system 200 of FIGS. 1 and 2, respectively.

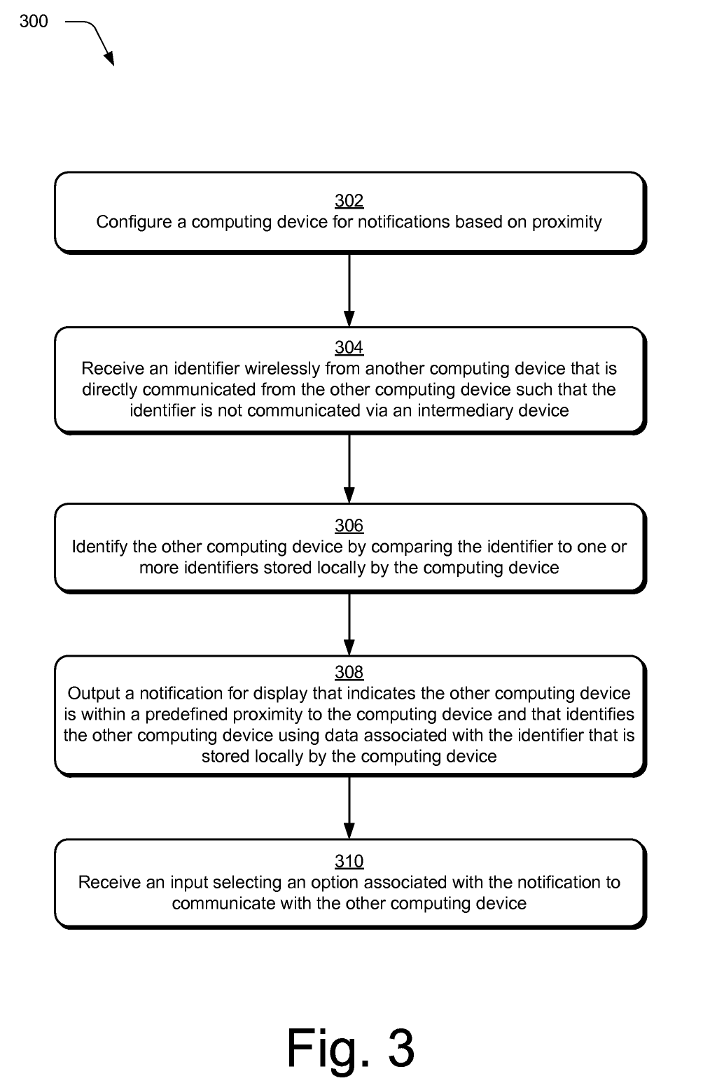

FIG. 3 depicts a procedure 300 in an example implementation in which proximity of computing devices is determined using direct communication between the devices and used as a basis to output a notification. A computing device is configured for notification based on proximity (block 302). A user of the computing device 102, for instance, may register and configure proximity notification for a particular computing device 104. This may include associating an identifier 114 with a contact 208. As previously described, the identifier 114 may take a variety of forms to uniquely identify the computing device. For example, the identifier 114 may be used to uniquely identify wireless functionality of the computing device, such as a MAC address. The identifier 114 may also be a name assigned to the wireless functionality, such as a name of a WAP enabled by the computing device 104.

An identifier is received wirelessly from another computing device that is directly communicated from the other computing device such that the identifier is not communicated via an intermediary device (block 304). For example, the identifier 114 may be received wirelessly without communication through a third-party service, a wireless access point, and so on. Additionally, the identifier may be received wirelessly via a push technique from the computing device 104 such that the computing device 102 does not transmit a request for the identifier, although other implementations are also contemplated.

The other computing device is identified by comparing the identifier to one or more identifiers stored locally by the computing device (block 306). The proximity module 112, for instance, may compare the identifier to identifiers stored as part of the contacts by the computing device 102. In this way, the proximity module 112 may identify with “who” the computing device 104 is associated. This may be performed in a variety of ways, such as to leverage an existing output of a detect device so long as there is identifying information, e.g., using “hotspot” identifying functionality. Therefore, it may be possible to identify a user without that user having the “turn on” this functionality.

A notification is then output for display that indicates the other computing device is within a predefined proximity to the computing device and that identifies the other computing device using data associated with the identifier that is stored locally by the computing device (block 308). As shown in FIG. 1, for instance, the notification may include part of the contact information. A variety of other instances are also contemplated, such as to include the identifier itself

The notification may also include one or more options as shown in FIG. 1. An input may then be received selecting an option associated with the notification to communicate with the other computing device (block 310). For example, a user may select an option to communicate directly with the computing device 104 via a phone call or text. In another example, a user may select an option to communicate with the user associated with the contact, such as via email such that this communication may be retrieved from a variety of different devices. The user may also choose to notify that “they are close,” e.g., by causing a proximity module of the other computing device 104 to also output a notification that identifies a user of the computing device 102 and/or the computing device 102 itself. A variety of other examples are also contemplated which may be found beginning in relation to the following figure.

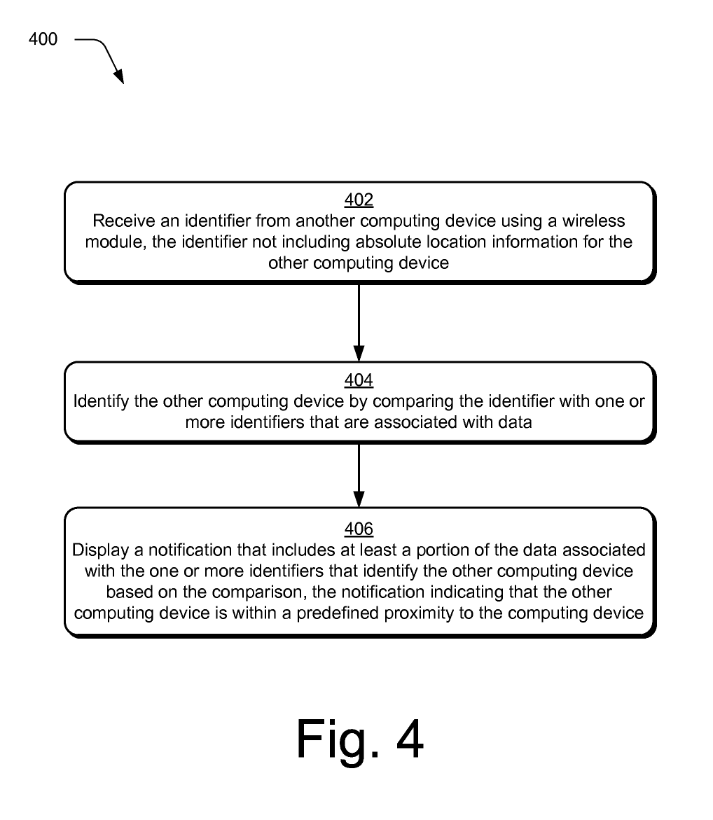

FIG. 4 depicts a procedure 400 in an example implementation in which proximity of computing devices is determined without using data that describes an absolute location of the devices and is used as a basis to output a notification. An identifier is received from another computing device using a wireless module, the identifier not including absolute location information for the other computing device (block 402). The identifier 114, for instance, may be configured to identify the computing device 104 but not a location of the computing device 104, does not include coordinates such as GPS coordinates that may be used to identify a specific location of the device.

The other computing device is identified by comparing the identifier with one or more identifiers that are associated with data (block 404). As previously described, the proximity module 112 may make a comparison using data in local storage 116 to determine an identity of the computing device 104. A variety of other examples are also contemplated, such as to use data accessible remotely via a network, e.g., from a service via the Internet.

A notification is displayed that includes at least a portion of the data associated with the one or more identifiers that identify the other computing device based on the comparison, the notification indicating that the other computing device is within a predefined proximity to the computing device (block 406). The notification, for example, may identify the computing device 104 using the data described above in a user interface, identify that the computing device 104 is within range, indicate a relatively proximity at which the computing device 104 is located, options to contact the computing device 104, and so on. A variety of other examples are also contemplated.

Example Device

FIG. 5 illustrates various components of an example device 500 that can be implemented as any type of computing device as described with reference to FIGS. 1 and 2 to implement embodiments of the techniques described herein. Device 500 includes communication devices 502 that enable wired and/or wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image data. Device 500 includes one or more data inputs 506 via which any type of data, media content, and/or inputs can be received, such as user-selectable inputs, messages, music, television media content, recorded video content, and any other type of audio, video, and/or image data received from any content and/or data source.

Device 500 also includes communication interfaces 508 that can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices communicate data with device 500.

Device 500 includes one or more processors 510 (e.g., any of microprocessors, controllers, and the like) which process various computer-executable instructions to control the operation of device 500 and to implement embodiments of the techniques described herein. Alternatively or in addition, device 500 can be implemented with any one or combination of hardware, firmware, or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 also includes computer-readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 516.

Computer-readable media 514 provides data storage mechanisms to store the device data 504, as well as various device applications 518 and any other types of information and/or data related to operational aspects of device 500. For example, an operating system 520 can be maintained as a computer application with the computer-readable media 514 and executed on processors 510. The device applications 518 can include a device manager (e.g., a control application, software application, signal processing and control module, code that is native to a particular device, a hardware abstraction layer for a particular device, etc.). The device applications 518 also include any system components or modules to implement embodiments of the techniques described herein. In this example, the device applications 518 include an interface application 522 and an input/output module 524 that are shown as software modules and/or computer applications. The input/output module 524 is representative of software that is used to provide an interface with a device configured to capture inputs, such as a touchscreen, track pad, camera, microphone, and so on. Alternatively or in addition, the interface application 522 and the input/output module 524 can be implemented as hardware, software, firmware, or any combination thereof Additionally, the input/output module 524 may be configured to support multiple input devices, such as separate devices to capture visual and audio inputs, respectively.

Device 500 also includes an audio and/or video input-output system 526 that provides audio data to an audio system 528 and/or provides video data to a display system 530. The audio system 528 and/or the display system 530 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, the audio system 528 and/or the display system 530 are implemented as external components to device 500. Alternatively, the audio system 528 and/or the display system 530 are implemented as integrated components of example device 500.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
receiving an identifier wirelessly from another computing device that is directly communicated from the other computing device such that the identifier is not communicated via an intermediary device;
identifying the other computing device by comparing the identifier to one or more identifiers stored locally by the computing device; and
outputting a notification for display that indicates the other computing device is within a predefined proximity to the computing device and that identifies the other computing device using data associated with the identifier that is stored locally by the computing device.

2. A method as described in claim 1, wherein the identifier does not identify coordinates of a physical location of the other computing device.

3. A method as described in claim 1, wherein the identifier of the other computing device uniquely identifies wireless functionality of the other computing device.

4. A method as described in claim 1, wherein the identifier is received by the computing device using Wi-Fi, Wi-MAX, or in accordance with a short range wireless technology that has an effective range that is less than Wi-Fi.

5. A method as described in claim 1, wherein the identifier is received by the computing device using functionality that is configured to identify a wireless access point.

6. A method as described in claim 1, wherein the identifier is received wirelessly via a push communication technique from the other computing device.

7. A method as described in claim 1, wherein the identifier is a Media Access Controller (MAC) address.

8. A method as described in claim 1, wherein the identifier is a name assigned by a user of the other computing device to identify wireless functionality of the other computing device.

9. A method as described in claim 1, wherein the data stored locally on the computing device is contact information that identifies a likely user of the other computing device.

10. A method as described in claim 1, wherein the identifier is received wirelessly by the computing device without transmitting a request for the identifier.

11. A method as described in claim 1, wherein the identifier is not configured to enable access to the other computing device as a wireless access point.

12. A method as described in claim 1, wherein the computing device and the other computing device are each configured as mobile communication devices that are configured to be held in a hand of a user and to include wireless phone functionality.

13. A computing device comprising:
a wireless module configured to communicate wirelessly with another computing device; and
one or more modules implemented at least partially in hardware and configured to detect the other computing device by:
receiving an identifier from the other computing device using the wireless module, the identifier not including absolute location information for the other computing device; and
identifying the other computing device by comparing the identifier with one or more identifiers that are associated with data.

14. A computing device as described in claim 13, wherein the one or more modules are further configured for displaying a notification that includes at least a portion of the data associated with the one or more identifiers that identify the other computing device based on the comparison, the notification indicating that the other computing device is within a predefined proximity to the computing device.

15. A computing device as described in claim 13, wherein the identifier is received directly at the computing device from the other computing device without being communicated through an intermediary device.

16. A computing device as described in claim 13, wherein the identifier uniquely identifies wireless functionality of the other computing device.

17. A computing device as described in claim 13, wherein the identifier is a Media Access Controller (MAC) address.

18. A computing device as described in claim 13, wherein the computing device and the other computing device are each configured as mobile communication devices that are configured to be held in a hand of a user and to include wireless phone functionality.

19. One or more computer-readable storage media comprising instruction stored thereon that, responsive to execution by a computing device, cause the computing device to perform operations comprising:
identifying another computing device by comparing an identifier received wirelessly from the other computing device to one or more identifiers stored locally by the computing device;
obtaining contact information that corresponds to the other computing device based on the identifying; and
outputting a notification for display by the computing device that includes at least a portion of the contact information and that indicates the contact is within a predefined proximity to the computing device.

20. One or more computer-readable storage media as described in claim 19, wherein the identifier is received directly at the computing device from the other computing device without being communicated through an intermediary device.
